(19) United States
(12) Patent Application Publication
(10) Pub. No.: US 2024/0375921 A1
(43) Pub. Date: Nov. 14, 2024

(54) Wheel dolly

(71) Applicant: WS Wieländer + Schill Engineering GmbH & Co. KG, Tuningen (DE)

(72) Inventor: Klaus REITZIG, Lüdenscheid (DE)

(73) Assignee: WS Wieländer + Schill Engineering GmbH & Co. KG, Tuningen (DE)

(21) Appl. No.: 18/659,100

(22) Filed: May 9, 2024

(30) Foreign Application Priority Data
May 11, 2023 (DE) 20 2023 102 546.3

(51) Int. Cl. B66F 7/24

(52) U.S. Cl. CPC B66F 7/246

(57) ABSTRACT

The disclosure relates to a wheel dolly for vehicles, comprising wheels and two arms that are moveable towards one another, wherein the arms can be positioned laterally under a vehicle wheel, wherein the vehicle wheel can be lifted by moving the arms towards one another, wherein the arms can be moved towards one another using a lever. The arms can be moved towards one another by a mechanism which comprises a rod that can be moved step by step by virtue of a sliding member which engages around the rod, and which can be clamped using a stopping member.

### CROSS-REFERENCE TO RELATED APPLICATION

This application claims the benefit of German Patent Application DE 20 2023 102 546.3, filed on May 11, 2023, the content of which is incorporated by reference in its entirety.

### TECHNICAL FIELD

The disclosure relates to a wheel dolly, in particular for motor vehicles. The disclosure furthermore relates to a pressing and/or spreading mechanism which is in particular designed for a wheel dolly.

### BACKGROUND

Wheel dollies are used in the workshop sector in particular. For example, wheel dollies known from practice comprise wheels and arms that can be moved towards one another. The arms reach under the vehicle wheel from either side thereof. The vehicle wheel is lifted by moving the arms towards each other. The vehicle wheel will then stand on the bearing rollers of the wheel dolly hovering above the ground on the wheels of the wheel dolly. If a wheel dolly is arranged under each wheel, the vehicle can be moved manually in any direction, even in confined spaces.

Wheel dollies known from practice usually comprise a hydraulic mechanism that can be operated using a foot lever. Such a hydraulic system is complex to manufacture, at least if it is intended to be of high quality. In addition, a hydraulic system requires regular maintenance, and pressure losses can occur due to hydraulic oil flowing past the hydraulic piston.

### SUMMARY

The present disclosure describes a reliable wheel dolly and a pressing and/or spreading mechanism in which complex hydraulics can be dispensed with. The disclosure further provides a wheel dolly which can be used flexibly for different wheel sizes and/or which provides improved stability, especially also on uneven ground.

In a first aspect, a wheel dolly for vehicles, in particular for motor vehicles, comprises dolly wheels and two arms that can move towards one another. The dolly wheels of the wheel dolly are preferably rotatable through 360° around a vertical axle. This allows the vehicle to be moved in any direction.

The arms preferably each comprise at least one, most preferably two rollers and can be positioned laterally under the vehicle wheel.

The vehicle wheel can be lifted by moving the arms towards each other.

The wheel dolly comprises a mechanism with a lever that can be used to move the arms towards each other. The lever may in particular be in the form of a foot lever.

The mechanism comprises a preferably smooth rod. The rod extends through a guide and can be moved using an advance mechanism of the lever.

For this purpose, a sliding member is used, which engages around the rod and moves the rod step by step when the lever is pressed.

For this purpose, the lever may in particular comprise an extension which engages in a recess in the sliding member and moves it a bit when the lever is pressed down, while the sliding member engages on the rod in a clamping manner.

Thus, upon advancement the sliding member is coupled to the rod in a frictional fit.

After a stroke, the lever returns to its starting position, in particular by virtue of a spring. The sliding member also moves back, preferably by spring force, and can then be moved for the next stroke of the lever.

During advancement, the sliding member is tilted in such a way that it clamps onto the rod. This can be achieved in particular by the lever engaging the sliding member from one side so that the latter engages in a clamping manner during a stroke. As soon as no force is exerted anymore on the lever, the clamping will be released and the sliding member can also return to its starting position, preferably by virtue of a spring.

The mechanism furthermore comprises a stopping member, by means of which the rod can be clamped at the end of the stroke.

The stopping member can also be designed to be tiltable. When the lever is actuated, the rod is moved against the clamping effect of the tilting of the stopping member and can therefore be moved in one direction, namely the direction in which the arms are moved towards one another. However, by virtue of a clamping connection with the rod the stopping member prevents the rod from moving back when the vehicle is lifted. In this way, the vehicle can be raised step by step, functionally comparable to a hydraulic pump mechanism. By using two separate elements, namely the sliding member for moving the rod and the stopping member for retaining the rod, it is possible to provide a mechanism which is even suitable for lifting heavy loads, in particular more than 750 kg, while at the same time requiring little pressure force on the lever.

In principle, the rod may have any geometry and be hollow inside. Preferably, the rod is made of solid material.

Furthermore, the rod preferably has a circular cylindrical shape. Due to a circular cylindrical design, the rod can be rotated relative to its seat, at least when it is not clamped in place. This in particular allows the arms of the wheel dolly to be rotated relative to each other. Thus, the arms of the wheel dolly are also able to adapt to uneven surfaces when placed against the vehicle.

Preferably, the stopping member can be released for lowering the vehicle, in particular using a release lever.

The release lever may, for example, comprise an eccentric or a half shaft coupled to the release lever, which will pivot the stopping member against its tilting and thus release the clamping. Due to the weight of the vehicle, the arms of the wheel dolly will so be moved apart again. Once the vehicle has been lowered, the wheel dolly can be removed sideways away from the vehicle.

The stopping member is preferably also tiltable against a spring bias.

A spring for pushing back the sliding member and/or for clamping the stopping member may in particular be guided on the rod itself. This enables a particularly compact and robust design of the mechanism for moving the rod.

According to one embodiment, the sliding member and/or the stopping member has a through-hole including one, preferably two opposing clamping surfaces on a side wall for clamping contact. The clamping therefore is not effected on the edges of the through-hole, but on its side wall. If the rod and through-hole are suitably dimensioned, the rod and/or the through-hole will deform such that it is not the edges but rather the opposite side walls of the through-hole that will rest against the rod. This prevents the edges of the through-hole from pressing into the rod, even under high forces.

The through-hole has a diameter that is larger than the outer diameter of the rod, in particular a diameter that is larger by 0.05 to 0.5 mm, preferably by 0.15 to 0.25 mm.

According to a further aspect, the disclosure relates to a wheel dolly for vehicles, in particular as described above.

The wheel dolly also comprises wheels and two arms that can be moved towards one another, and the arms can be positioned laterally under a vehicle wheel. The vehicle wheel can be lifted by moving the arms towards one another, and the arms can be moved towards one another using a lever.

The arms are configured so as to be pivotable relative to one another.

As already mentioned above, the wheel dolly is able to adapt to uneven surfaces in this way.

Preferably, the pivotability of the arms is provided by a rod with a circular cylindrical shape, which can be moved using the lever. One arm is arranged on the rod and the other arm on the rod support.

According to a further aspect, the disclosure relates to such a wheel dolly for vehicles, in particular as described above.

It also comprises arms that can be moved towards one another and by means of which the vehicle can be lifted.

One of the arms is arranged on the rod so as to be slidable thereon.

The arm can be connected to the rod at one end, in particular by means of a clamp. The clamp can be released so that the arm can be displaced on the rod.

The wheel dolly can thus be adapted to different wheel sizes in a very flexible manner and is therefore not limited by the maximum stroke of the rod in terms of adaptability to the size of the vehicle wheel.

According to a further aspect, the disclosure relates to a pressing and/or spreading mechanism.

The pressing and/or spreading mechanism is designed in particular for the wheel dolly described above and is therefore used to move the arms towards one another using a pressing mechanism.

The mechanism comprises a rod which can be moved step by step using a lever which engages on a sliding member.

The sliding member has a through-hole for the rod, and the side wall of the through-hole has at least one, preferably two opposing clamping surfaces.

A front edge of the through-hole is set back into the through-hole in the axial direction in the area of the clamping surface.

Thus, a front and/or rear edge of the through-hole does not lie on a single plane, but rather extends inwards in the area of the clamping surface.

It has been found that the clamping effect of the sliding member can be significantly enhanced in this way.

This is presumably due to the fact that when the sliding element is tilted, the edge of the through-hole will not come into contact at a single point in the central area of the clamping surface, but rather the forces will be distributed more evenly along the edge over a larger perimeter.

Due to a distortion of the rod and/or the through-hole, the side wall of the through-hole will be effective as a clamping surface and the edge of the through-hole does not press into the rod.

The pressing and/or spreading mechanism preferably also comprises a stopping member, as described above.

The through-hole of the stopping member is preferably formed like the through-hole of the sliding member and has a front edge which is set back axially into the through-hole in the area of the clamping surface.

In addition to being used for the wheel dolly as described above, the pressing and/or spreading mechanism can also be used for other assemblies. For example, a jack can be provided which, in contrast to the wheel dolly described above, does not act on the vehicle wheel but rather on the vehicle floor. The pressing and/or spreading mechanism can also be used, for example, for supports to prop up ceilings and the like or for a clamp. The set back front edge may in particular be provided by being recessed in a U-shape or arc shape.

The front edge may also be rounded.

According to one embodiment, the front edge is set back over a perimeter angle of 90° to 270°, preferably 150° to 220°.

According to one embodiment, the setback is defined by a recess that extends into the sliding member from end faces thereof and terminates at the lateral sides thereof.

The recess therefore only extends over part of the perimeter angle of the edge of the through-hole.

Due to a U-shaped or curved run-out, the setback preferably does not merge into the edge of the through-hole in a stepped manner, but rather gradually.

Preferably, the through-hole has a setback on both ends thereof.

This setback is provided on opposite ends and is therefore located adjacent to the clamping surface of the side wall of the through-hole.

### BRIEF DESCRIPTION OF THE DRAWINGS

The subject-matter of the invention will now be explained in more detail with reference to the drawings of FIGS. 1 through 15.

FIG. 1 is a perspective view of a wheel dolly as used on a vehicle.

FIG. 2 is a perspective view of the wheel dolly alone.

FIG. 3 is a detailed view of the wheel dolly illustrating the portion for moving the arms towards one another.

FIG. 4 is a detailed view with the housing omitted.

FIG. 5 is a detailed longitudinal sectional view of the pressing mechanism.

FIG. 6 is a further detailed view with the housing omitted.

FIGS. 7 and 8 are perspective views of the sliding member.

FIGS. 9 to 12 are cutaway views of the sliding member.

FIGS. 13 and 14 are perspective views of the stopping member.

FIG. 15 is a longitudinal sectional view of the stopping member.

### DETAILED DESCRIPTION

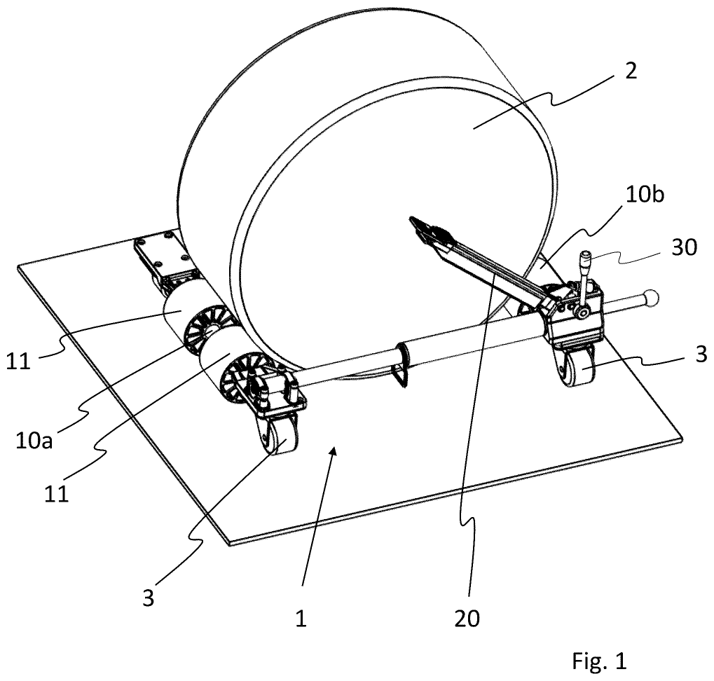

FIG. 1 shows a perspective view of a wheel dolly 1 as used to lift a vehicle. Only the vehicle wheel 2 of the vehicle is shown.

The wheel dolly 1 has a U-shaped configuration and comprises the two arms 10a, 10b, which can be moved towards one another using a pressing mechanism.

Wheels 3 are arranged below the ends of the arms, which wheels can be rotated through 3600 about a vertical axis.

Each arm comprises two rotatable rollers 11 which are displaceable on and along the arms 10a, 10b.

The rollers 11 can also be moved along the arms 10a, 10b in order to adjust the wheel dolly to different tire widths.

The arms 10a, 10b are positioned under the vehicle wheel 2 on either side thereof.

The user then steps on the lever 20 and the arms 10a, 10b will move towards one another step by step. The vehicle wheel 2 will thus be lifted off the ground. When equipped with a respective wheel dolly at each vehicle wheel 2, the vehicle can then be moved on the wheels 3 of the wheel dolly 1.

To lower the vehicle, the user can operate the release lever 30. When the release lever 30 is actuated, the arms 10a, 10b will be able to move apart again. The arms 10a, 10b will be pushed apart by virtue of the vehicle's weight so that the vehicle will be lowered again.

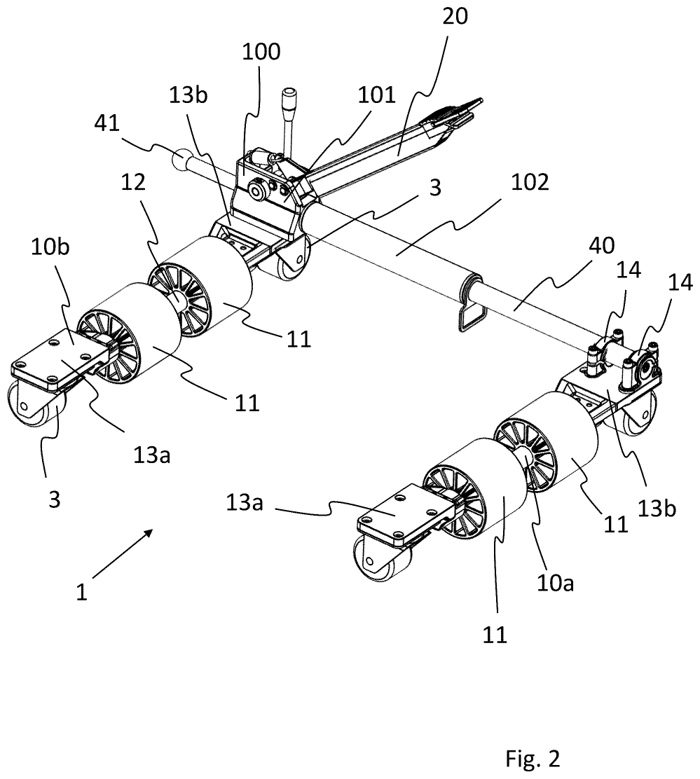

FIG. 2 is a perspective view of the wheel dolly 1. Wheel dolly 1 has a U-shaped configuration.

A pressing mechanism 100 is used as the mechanism for moving the arms 10a, 10b towards one another. Pressing mechanism 100 comprises a housing 101 which is arranged at one end of arm 10b.

Housing 101 accommodates the lever 20 which is pivotally mounted therein.

By operating the lever 20, rod 40 guided in guide tube 102 can be retracted step by step.

This will cause the arm 10a to move towards arm 10b.

Rod 40 extends through the housing 101 and comprises a stop 41 on the end opposite of arm 10a.

Rod 40 has a circular cylindrical shape and can be rotated inside guide tube 102. In this way, the arms 10a, 10b are pivotable about an axis corresponding to the central axis of rod 40.

The ends of arms 10a, 10b are defined by wheel holders 13a, 13b. Housing 101 of the pressing mechanism is arranged on one of the wheel holders, 13b.

Each axle 12 of the arms 10a, 10b extends between the respective wheel holders 13a, 13b.

Each pair of rollers 11 can be displaced on and along the respective axle 12.

Arm 10a is coupled to the rod 40 by clamps 14 that are arranged on wheel holder 13b. These clamps can be loosened by loosening the screws of the clamps 14. Thus, the wheel carrier 13b of arm 10a can be moved along rod 14 and fixed again by tightening the clamps 14. This allows the wheel dolly to be adjusted to different wheel sizes in an improved manner.

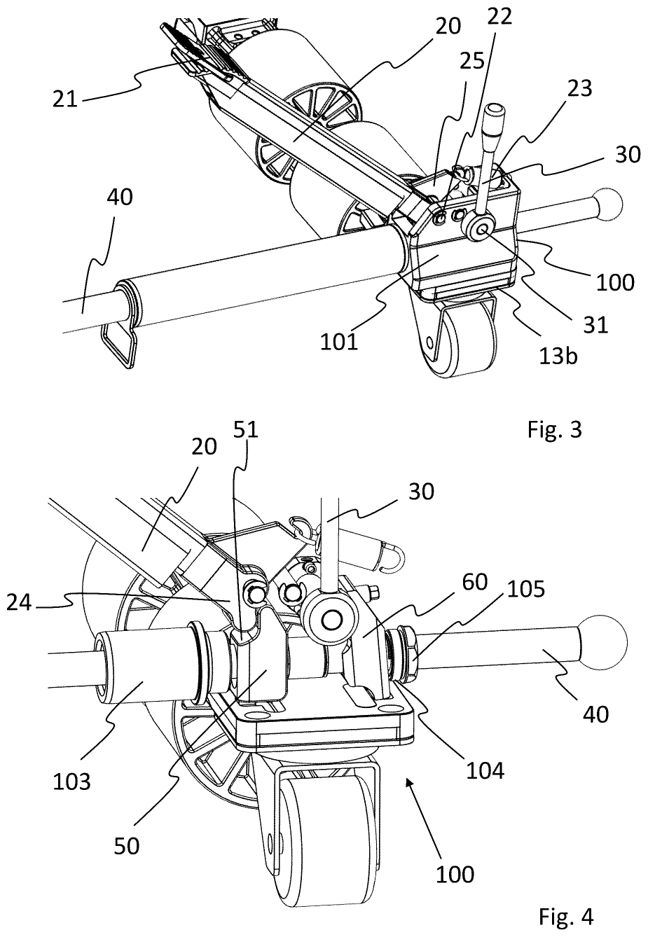

FIG. 3 is a detailed view of the portion of pressing mechanism 100.

Lever 20 is pivotally mounted on shaft 22 which extends through the housing 101. Lever 20 includes a footrest 21 to press it down.

Spring 23, which is coupled to the housing 101 on one end and engages on the arm 25 of lever 22 on its other end, is effective to move the lever 20 back into its starting position shown here after it has been pressed down. Pressing down the lever 20 will move the rod 40 step by step.

The release lever 30 comprises a shaft 31, which is also guided in the housing 101.

FIG. 4 is a perspective view of the portion of the pressing mechanism 100, with the upper portion of the housing being omitted now.

As can be seen now, rod 40 is mounted in a guide 103 which is accommodated in the guide tube.

In order to move the rod 40, the mechanism comprises the sliding member 50 which can be moved using the lever 20.

For this purpose, lever 20 has a rounded extension 24 which engages in a recess 51 of the sliding member 50 from above.

Thus, sliding member 50 is moved by the extension 20. Since the extension 24 engages from one side, namely from above, the sliding member 50 will be tilted at the same time as it is moved, thereby engaging on the rod 40 in a clamping manner.

Stopping member 60 is also arranged on the rod.

At its lower end, stopping member 60 sits in a recess 104 in the lower housing portion of the pressing mechanism. Stopping member 60 is tilted due to spring bias. When rod 40 is moved via sliding member 50, stopping member 60 will be moved against the tilt, so that the clamping connection is released when the rod 40 is moved. At the end of a stroke, the stopping member 60 will again establish a frictional fit with rod 40 due to a clamp connection and will retain the rod 40.

A cap 105 screwed into the housing keeps a spring biased thereby holding the stopping member in the blocking position (107 in FIG. 5).

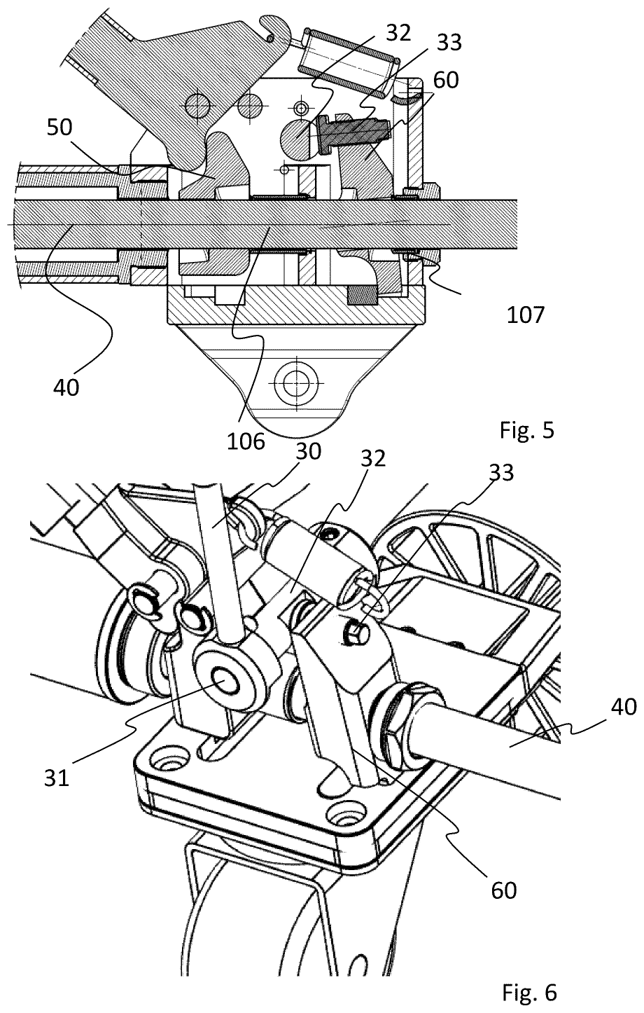

FIG. 5 is a longitudinal sectional view of the pressing mechanism including sliding member 50 and stopping member 60, cut centrally through the rod 40. FIG. 6 is a perspective view with the housing omitted.

When the rod 40 is moved, sliding member 50 is moved against the bias of spring 106. Spring 106 is in the form of a spiral spring and is fitted around the rod.

Stopping member 60 is held in its tilted position shown here by spiral spring 107 which is also guided on rod 40, thus establishing a frictional fit with the rod when the sliding member is not moved.

Release lever 30 comprises a shaft 31 having a half shaft section 32 which is coupled to the stopping member 60 via a coupling bar 33.

When the release lever 30 is actuated from the position shown here into a release position, the tilting of stopping member 60 will be released, as the coupling bar driven by the half shaft section 32 will lever the stopping member 60 out of its tilted position and thereby release the frictional fit.

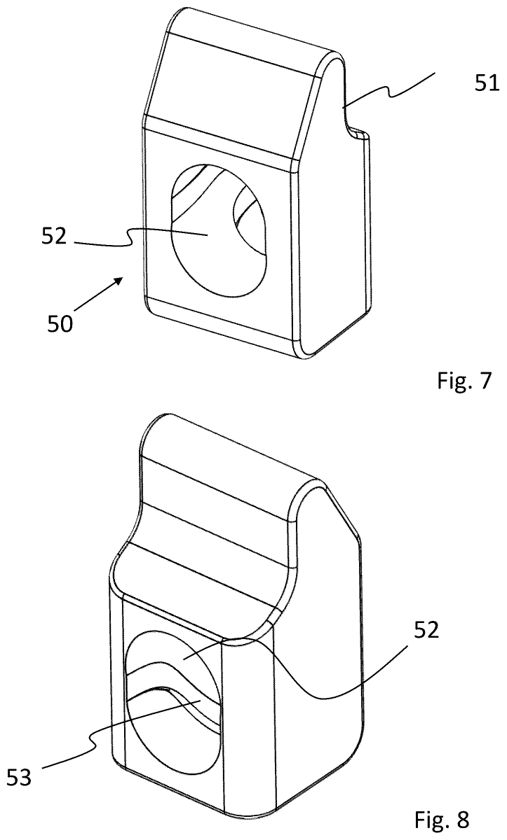

FIGS. 7 and 8 are perspective views of sliding member 50.

On the one hand, sliding member 50 has a through-hole 52 through which the rod extends.

Sliding member 50 furthermore has a recess 51 in which the extension of the lever engages.

As shown in FIG. 8, a setback 53 is provided at the edge of the through-hole, which improves the clamping engagement of sliding member 50. The clamping surface is defined by the area of the through-hole 52 adjacent to the recess. It will be appreciated that the clamping surface is not a geometrically clearly defined area, but rather depends on the force that is applied and on the force-related deformation of sliding member 50 and of the rod, among other things.

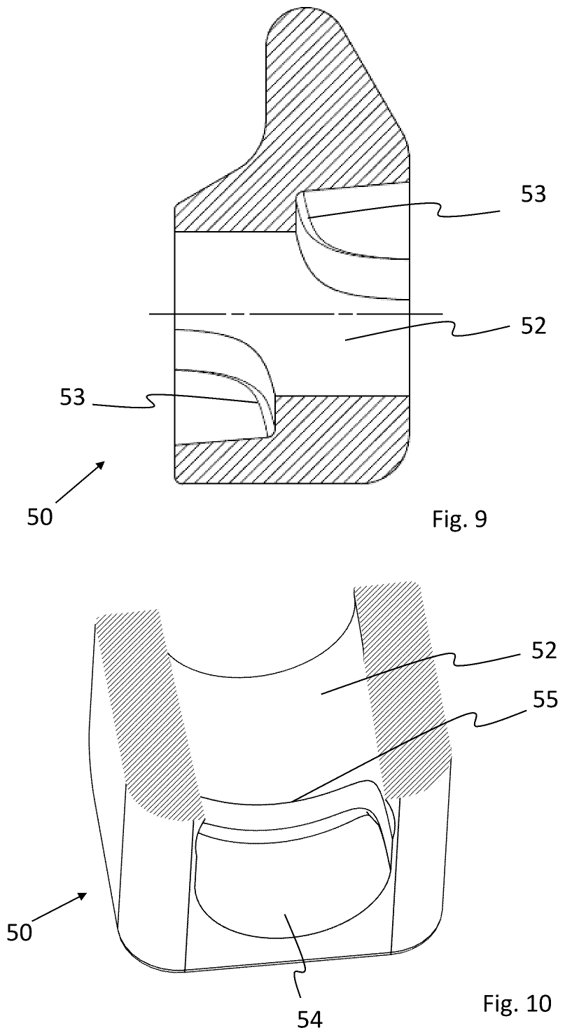

FIG. 9 is a longitudinal sectional view through the center of sliding member 50. In the area of setback 53 there is a recess which increases the diameter of the through-hole along a perimeter portion.

Such a setback 53 is provided at the top and bottom respectively, on two opposite ends.

The actual through-hole 52 which can be engaged on the rod in a clamping manner only extends as far as to the setback 53 in each case.

As can be seen in the cut-away view of FIG. 10, the edge 55 of through-hole 52 is U-shaped. The recess 54 runs out on the lateral sides with respect to the perimeter.

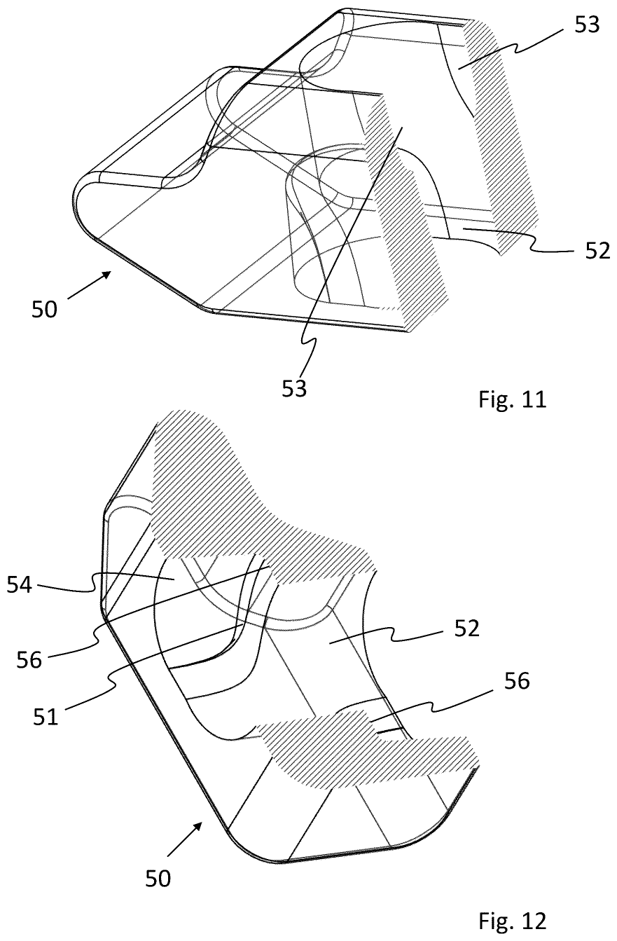

As shown in the cut-away view of FIG. 11, the setback 53 runs out gradually. The setback 53 may in particular be provided by milling into the sliding member 50 on the end face of the through-hole 52.

As shown in a cut-away view in FIG. 12, the through-hole 52 thus extends up to a step 56 which is defined by the recess 51. Since the recess 51 runs out on the perimeter, the height of step 51 decreases gradually to a portion of the edge of the through-hole where the edge lies on a plane.

The recess 54 preferably extends over approximately half the perimeter of the through-hole 52.

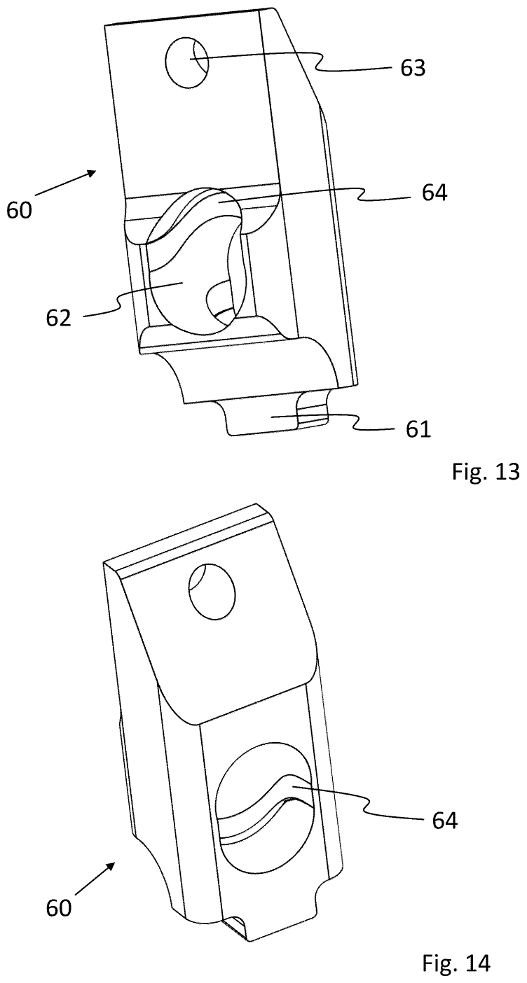

FIGS. 13 and 14 are perspective views of the stopping member 60.

In contrast to the sliding member, stopping member 60 has an extension 61 on its underside, by virtue of which the stopping member 60 engages in the housing of the pressing mechanism.

In an upper portion, a through-hole 63 is provided in which the coupling bar for the release lever engages.

Through-hole 62 is formed similar to the through-hole of the sliding member and also has a setback 64 on two opposite sides, which is formed similar to those of the sliding member.

Sliding member and stopping member 60 work in different directions, i.e. when the sliding member is coupled to the rod in a frictional fit, the frictional fit of stopping member 60 is released against a spring bias upon advancement.

When the lever moves back, stopping member 60 will retain the rod due to a frictional fit, while the frictional fit of the sliding member is released.

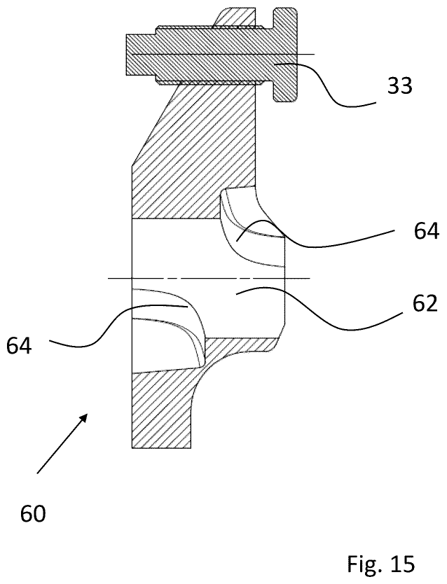

FIG. 15 is a longitudinal sectional view similar to that of FIG. 9, but of stopping member 60 together with coupling bar 33.

Similarly to the sliding member, the edge of through-hole 62 extends along a respective setback 64 provided diagonally opposite each other, which runs out with its perimeter towards the lateral side opposite the clamping surface.

The invention made it possible to provide a robust, flexibly usable and simply configured wheel dolly for vehicles.

### LIST OF REFERENCE NUMERALS

1 The wheel dolly
2 Vehicle wheel
3 Wheel
10a, 10b Arm
11 Roller
12 Axle
13a, 13b Wheel holder
14 Clamp
20 Lever
21 Footrest
22 Shaft
23 Return spring
24 Extension
25 Arm
30 Release lever
31 Shaft
32 Half shaft section
33 Coupling bar
40 Rod
41 Stop
50 Sliding member
51 Recess
52 Through-hole
53 Setback
54 Recess
55 Edge
56 Step
60 Stopping member
61 Extension
62 Through-hole
63 Through-hole (for coupling bar)
64 Setback
100 Pressing mechanism
101 Housing
102 Guide tube
103 Guide
104 Recess
105 Cap
106 Spring (sliding member)
107 Spring (stopping member)

What is claimed is:

1. A wheel dolly for vehicles, comprising:
two arms that are moveable towards one another,
dolly wheels, one dolly wheel being arranged at each end of each of the two arms; and
a mechanism for moving the two arms towards one another, including
a lever,
a rod,
a sliding member, and
a stopping member,
wherein the two arms can be positioned laterally under a vehicle wheel,
wherein the vehicle wheel can be lifted by moving the two arms towards one another,
wherein the rod that can be moved step by step by the sliding member,
wherein the sliding member engages around the rod, and
wherein the rod can be clamped by the stopping member.

2. The wheel dolly as in claim 1,
wherein the stopping member can be released using a release lever for lowering the vehicle wheel.

3. The wheel dolly as in claim 1,
wherein each of the two arms comprises rollers that can be displaced along each respective one of the two arms.

4. The wheel dolly as in claim 1,
wherein the sliding member is movable against a spring bias.

5. The wheel dolly as in claim 1,
wherein the stopping member is tiltable against a spring bias.

6. The wheel dolly as in claim 1,
wherein the rod has a cylindrical shape.

7. The wheel dolly as in claim 1,
wherein the sliding member and/or the stopping member has a through-hole with two clamping surfaces on a side wall thereof.

8. A wheel dolly for vehicles, comprising:
wheels; and
two arms that can be moved towards one another,
wherein the two arms can be positioned laterally under a vehicle wheel,
wherein the vehicle wheel can be lifted by moving the two arms towards one another,
wherein the two arms can be moved towards one another using a lever, and
wherein the two arms are pivotable relative to one another.

9. A wheel dolly for vehicles, comprising:
wheels; and
two arms that can be moved towards one another,
wherein the two arms can be positioned laterally under a vehicle wheel,
wherein the vehicle wheel can be lifted by moving the two arms towards one another,
wherein the two arms can be moved towards one another using a lever,
wherein the two arms can be moved towards one another by a mechanism which comprises a rod that can be moved step by step using the lever,
wherein one of the two arms is arranged on the rod so as to be slidable thereon.

10. A pressing and/or spreading mechanism, comprising:
a rod that can be moved step by step using a lever that engages on a sliding member,
wherein the sliding member has a through-hole for the rod,
wherein a side wall of the through-hole has a clamping surface for the rod, and
wherein a front edge of the through-hole is set back axially into the through-hole in an area of the clamping surface.

11. The pressing and/or spreading mechanism as in claim 10,
wherein the front edge is set back in a U-shape or arc shape.

12. The pressing and/or spreading mechanism as in claim 10,
wherein the front edge is set back over a perimeter angle of 150° to 220°.

13. The pressing and/or spreading mechanism as in claim 10,
wherein a setback is defined by a recess that extends into the sliding member from end faces thereof and terminates at lateral sides thereof.

14. The pressing and/or spreading mechanism as in claim 10,
wherein the through-hole and the rod have a cylindrical shape.

15. The pressing and/or spreading mechanism as in claim 14,
wherein the through-hole has a diameter that is larger by 0.15 to 0.25 mm, than an outer diameter of the rod.
